(19) United States
(12) Patent Application Publication
(10) Pub. No.: US 2006/0166059 A1
(43) Pub. Date: Jul. 27, 2006

(54) Arrangement and method for continuously supplying electric power to a field device in a technical system

(75) Inventors: Guntram Scheible, Hirschberg (DE); Ray Keech, Glos (GB)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ABB Research Ltd., Zurich (CH)

(21) Appl. No.: 10/548,538

(22) PCT Filed: Mar. 12, 2003
(86) PCT No.: PCT/EP03/02527

§ 371 Date: Dec. 30, 2005

(51) Int. Cl. H01M 8/02; H01M 8/04

(52) U.S. Cl. 429/25; 429/34; 429/13

(57) ABSTRACT

An arrangement is described for supplying electrical power to a field device in a process installation which is equipped with a wire-free communication interface without the use of wires. At least one fuel cell having a membrane/electrode block and a fuel tank as well as an electrical energy store are integrated in a housing in the field device, with the fuel cell being equipped with an oxygen reservoir which provides the oxygen that is required for production of electrical energy by oxidation of the fuel in the membrane/electrode block. In addition, the fuel cell is equipped with a water reservoir unit which holds the water which is created during the production of electrical power in the membrane/electrode block by oxidation of the fuel with the oxygen. The fuel cell together with the membrane/electrode block, the fuel tank, the oxygen reservoir and the water reservoir unit form a modular, closed system.

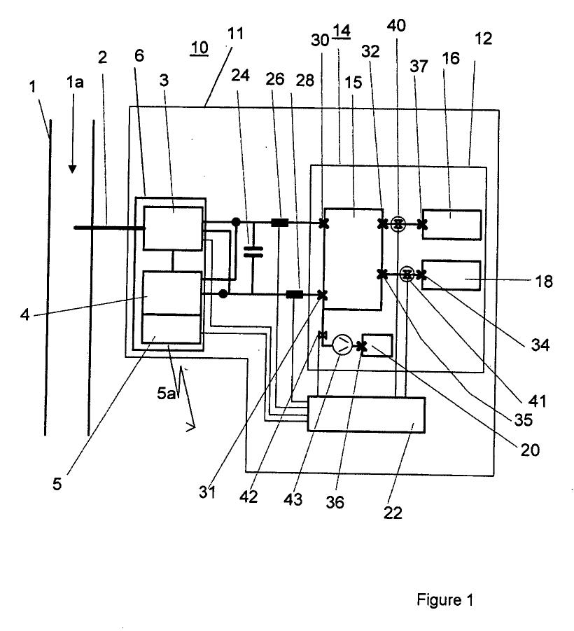

The invention relates to an arrangement for supplying electrical power to a field device in a process installation which is equipped with a wire-free communication interface, without the use of wires, as claimed in the precharacterizing clause of claim 1. The invention also relates to a method for supplying electrical power to a , field device in a process installation without the use of wires, as claimed in the precharacterizing clause of claim 12.

Field devices which are equipped with a wire-free communication interface, for example a GPRS or Bluetooth interface, are known for use in process installations, with appliances such as these having not only a sensor/actuator unit which includes the actual measurement or control module, a control, data acquisition and processing module and the wire-free communication interface as well, but also a power generation and production unit for supplying power to the field device within a housing, without the use of wires. A variant of a power generation and production unit which uses a fuel cell appears to be particularly advantageous in this case. A fuel cell, in which (as is known) electrical power and water are produced by oxidation of a fuel with oxygen in a membrane/electrode block, has an energy density which is at least 20 times greater than, for example, a lead-acid rechargeable battery, that is to say a power generation and production unit which uses a fuel cell can be designed to be considerably more compact and to be cheaper than a lead-acid rechargeable battery with the same capacity. This is particularly important for supplying electrical power to field devices in process installations. DE 201 07 114 U1 describes an arrangement such as this where the fuel is taken directly from a fuel line. In order to ensure a continuous and uninterruptible electrical power supply to the field device even in the event of the fuel supply briefly failing, an energy store is provided in the system according to DE 201 07 114, as a temporary store for the electrical energy that is produced.

Since fuel lines are not available in all application situations, it has been proposed that a fuel reservoir also be provided directly as part of the power generation and production unit. DE 199 29 343 describes a corresponding arrangement for supplying electrical power to a large number of sensors and/or actuators without the use of wires, with a micro fuel cell with an associated fuel tank being integrated in each of the sensors. The required oxygen is obtained from the surrounding air, in the generally normal way for fuel cells that are used at the moment.

An arrangement such as this cannot, of course, be used when the field device is intended to be used in an environment in which no oxygen from the air is available. Fields of use such as these may, for example, be flowmeters which are buried in the ground together with a water pipe, or else when using field devices which have been made suitable for underwater use for flow, pressure or temperature measurement or for valve drives for submarine natural-oil supplies.

The efficiency of a conventional fuel cell as known at the moment is limited by the oxygen supply from the surrounding air, which is obtained by diffusion, and is thus limited. It is desirable to extend the possible uses of fuel cells in field devices by improving the efficiency of the fuel cell systems that are used.

The object of the present invention is thus to provide an arrangement for supplying electrical power to a field device in a process installation which is equipped with a wire-free communication interface, without the use of wires, using a fuel cell with a fuel tank and an energy store for supplying electrical power, which avoids the disadvantages of the known arrangements and, in particular, can also be used in environments without any oxygen from the air, and to develop a method for supplying electrical power to a field device in a process installation which is equipped with a wire-free communication interface, without the use of wires.

With regard to the arrangement, the object is achieved by the characterizing features of claim 1, and with regard to the method it is achieved by the characterizing features of claim 13.

Thus, according to the invention, the fuel cell is equipped with an oxygen reservoir which provides the oxygen that is required for production of electrical energy by oxidation of the fuel in the fuel cell. Furthermore, the fuel cell is equipped with a water reservoir unit which holds the water which is created during the production of electrical power in the membrane/electrode block by oxidation of the fuel with the oxygen. In particular, the fuel cell together with the membrane/electrode block, the fuel tank, the oxygen reservoir and the water reservoir unit form a closed system.

In one particularly advantageous refinement of the invention, the oxygen in the oxygen reservoir is pressurized. This is because the oxygen can then be supplied to the membrane/electrode block at an increased pressure, which improves the efficiency of the fuel cell.

It is highly advantageous to be able to regulate the pressure of the fuel at the interface between the fuel tank and the fuel cell by means of a fuel pressure regulating device and/or to be able to regulate the pressure of the oxygen at the interface between the oxygen reservoir and the fuel cell by means of an oxygen pressure regulating device. In this case, the fuel and/or oxygen pressure regulating devices may be mechanical pressure regulating valves, membrane pressure regulators or electronic pressure regulators.

Arrangements designed according to the invention are distinguished in that the power of the fuel cell can be adjusted and/or regulated, with the fuel pressure and/or the oxygen pressure being the manipulated variables.

A further advantageous refinement option for the invention provides that the water reservoir unit is a water tank which is connected to the membrane/electrode block.

In another highly advantageous refinement, the fuel cell is equipped with at least one current sensor for measurement of the electric current produced by it, or with an energy measurement device for measurement of the electrical energy produced by it.

However, one advantageous refinement of the invention can also be characterized in that the fuel cell together with the membrane/electrode block, the fuel tank, the oxygen reservoir, the water reservoir unit, the fuel pressure regulating device and the oxygen pressure regulating device which may be provided, the at least one current sensor or the at least one energy measurement device are in the form of a modular, closed system, with the membrane/electrode block, the fuel tank, the oxygen reservoir, the water reservoir unit, the fuel and/or oxygen pressure regulating device or devices and the at least one current sensor or the at least one energy measurement device being individually replaceable modules and having the capability to be connected to one another and/or to the fuel cell by detachable connecting apparatuses.

A further advantageous refinement option for the invention provides that the membrane/electrode block together with the fuel tank, the oxygen reservoir, the water reservoir unit, the fuel and/or oxygen pressure regulating device or devices and the current sensor or sensors or energy measurement devices are integrated in a pressure-resistant housing. For safety reasons, a pressure-relief valve can advantageously be installed in the pressure-resistant housing in this case; a pressure-relief valve can also be installed in the housing of the field device.

It is particularly advantageous to have the capability to regulate the fuel cell power by means of a micro-processor which is integrated in the field device or by means of a controller, with the microprocessor or controller being connected at least to the current sensor and/or to the energy measurement device for measurement of the electric current which is produced by the fuel cell or of the electrical energy which is produced by it, and being connected to the fuel and/or oxygen pressure regulating device or devices.

The microprocessor or controller can also be connected to the wire-free communication interface of the field device, so that information about the state of the fuel cell and/or details about the amount of electrical energy produced can be interchanged by the microprocessor or controller via the wire-free communication interface with a central unit which is located outside the field device.

Overall, an, apparatus according to the invention has the advantage that this has resulted in a field device with a wire-free communication device with a completely autonomous electrical power supply. The field device can thus be used in environments without any oxygen from the air. The energy density of the electrical power supply is approximately 20 times greater than that of lead-acid rechargeable batteries as are currently used in field devices. with a wire-free communication device, and its energy density is about 3 to 6 times greater than that of lithium-ion rechargeable batteries. The modular design of the arrangement according to the invention allows the field device to be installed and maintained highly cost-effectively, since all that is required for maintenance is to replace prefabricated modules, such as the fuel tank or the oxygen tank.

In principle, the advantages mentioned above apply to all types of field devices, but in particular to field devices with an overall power demand of a few milliwatts.

With regard to the method for supplying electrical power to a field device in a process installation which is equipped with a wire-free communication interface, without the use of wires, the essence of the invention is that the oxygen which is required for production of electrical power by oxidation of the fuel in the membrane/electrode block is provided from an oxygen reservoir with which the fuel cell is equipped, and that the water which is created during the production of electrical power in the membrane/electrode block by oxidation of the fuel with the oxygen is held in a water reservoir unit.

The pressure of the fuel at the interface between the fuel tank and the membrane/electrode block is regulated by means of a fuel pressure regulating device, and the pressure of the oxygen at the interface between the oxygen reservoir and the membrane/electrode block is regulated by means of an oxygen pressure regulating device.

The electric current which is produced by the fuel cell is measured by means of a current sensor; however, the electrical energy which is produced by the fuel cell can also be measured by means of an energy measurement device.

The power from the fuel cell is regulated, with the signal from the at least one current sensor or the signal from the at least one energy measurement device being the controlled variable, and the fuel pressure and/or the oxygen pressure being the manipulated variables.

The water which is created during the production of electrical power in the fuel cell on the basis of the oxidation of the fuel with the oxygen is supplied via a valve and a water pump to the water reservoir unit, and at least some of it can also be passed back once again from there as required to the membrane/electrode block. However, it would also be possible for the water that is created just to be collected within the pressure-resistant housing although, in this case, it would, of course, no longer be possible to feed even part of the water back into the membrane/electrode block.

In particular, it is advantageous for the fuel cell power to be regulated by means of a microprocessor which is integrated in the field device, or by means of a controller, and for the microprocessor or controller to be connected at least to the current sensor and/or to the energy measurement device for measurement of the electric current that is produced by the fuel cell, or of the electrical energy which is produced by it, and to the fuel and/or oxygen pressure measurement device or devices. In this case, the microprocessor or controller is advantageously connected to the wire-free communication interface of the field device such that information about the state of the fuel cell and/or details about the amount of electrical power produced can be interchanged by the microprocessor or controller via the wire-free communication interface with a central unit which is located outside the field device.

Further advantageous refinements and improvements of the invention, as well as further advantages, can be found in the dependent claims.

The invention as well as further advantageous refinements and improvements of the invention will be explained and described in more detail with reference to the drawing, which illustrates one exemplary embodiment of the invention.

As an exemplary embodiment, the single figure shows an arrangement for supplying power to a field device 10 without the use of wires, which field device 10 in the example illustrated here is an analysis appliance for analysis of the composition of a process medium which is carried in a pipeline 1 of a technical process and is represented by an arrow 1a in the figure. The field device 10 is surrounded by a housing 11 and has a sensor/actuator unit 6 which has the measurement or control module 3 (in this case also referred to as analysis modules in the following text), a control, data acquisition and processing module 4, and the wire-free communication interface 5 as well and a sampling line 2, by means of which a sample is taken from the process medium la flowing through the pipeline 1, and is supplied to the sensor/actuator unit 6. Depending on the process medium and the objective, the analysis module 3 may be an apparatus for automatic water or gas analysis, for example a process gas chromatograph, a process photometer, a process pH meter, a conductivity analyzer, a process nitrate analyzer, a process oxygen analyzer, or the like. The control, data acquisition and processing unit 4 monitors the sequence of the measurement process in the analysis module 3, controls the recording of measurement data and, if required, carries out measurement data preprocessing. Data is interchanged by means of the wire-free communication interface 5 between the field device 10 and a central unit (which is not illustrated here). The data interchange is represented by the bidirectional arrow 5a.

The fuel cell 14 has a membrane/electrode block 15, a fuel tank 18, an oxygen reservoir 16 and a water reservoir unit 20. A current sensor 26 and an energy measurement device 28 are installed at the interface between the fuel cell 14 and the sensor/actuator unit 6. While the current sensor 26 measures the amount of current which is interchanged between the fuel cell 14 and the sensor/actuator unit 6, the energy measurement device 28 additionally contains an integration apparatus, by means of which a value for the electrical energy is determined from the time profile of the current. It would also be possible to provide just the current sensor 26 or just the energy measurement device 28.

Furthermore, an energy store 24 is installed at the interface between the fuel cell 14 and the sensor/actuator unit 6, as a temporary store for the electrical energy that is produced.

In the exemplary embodiment described here, hydrogen is used as the fuel. The membrane/electrode block 15 may be a polymer membrane/electrode block which is known per se and which can also be manufactured using micro-technical methods that are known per se, for the purpose of volume reduction and cost-saving. The fuel tank 18 is, for example, a pressurized hydrogen tank, which is known per se, or a metal hydride hydrogen reservoir, which is likewise known per se.

Alternatively, it is also possible to use a liquid fuel such as methanol or ethanol, with the fuel tank 18 then being a tank that is suitable for this purpose.

In the illustrated example, the oxygen reservoir 16 is a pressurized oxygen tank. The oxygen is thus pressurized in the oxygen reservoir 16.

The water reservoir unit 20 is a water tank, which is preceded by a valve 42.

The fuel tank 18, the oxygen reservoir and the water reservoir unit 20 are connected to the membrane/electrode block 15 via respectively suitable interfaces.

The interface between the fuel tank 18 and the membrane/electrode block 15 is a fuel pressure regulating device 41 with an integrated valve. It would also be possible to provide the valve separately from the fuel pressure regulating device. In a corresponding manner, the interface between the oxygen reservoir 16 and the membrane/electrode block 15 is formed by an oxygen pressure regulating device 40 with an integrated valve.

A bidirectional water feed device 43 is arranged at the interface between the water reservoir unit 20 and the membrane/electrode block 15, and cannot only pump water from the water reservoir unit 20 to the membrane/electrode block 15, but can also pump water from the membrane/electrode block 15 into the water reservoir unit 20.

The fuel cell 14 together with the membrane/electrode block 15, the fuel tank 18, the oxygen reservoir 16, the water reservoir unit 20, the fuel and oxygen pressure regulating devices 40, 41 and the current sensor 26 as well as the energy measurement device 28 are in the form of a modular, closed system. This means that the membrane/electrode block 15, the fuel tank 18, the oxygen reservoir 16, the water reservoir unit 20, the hydrogen and oxygen pressure regulating devices 40, 41, the current sensor 26 and the energy measurement device 28 are individually replaceable modules which can be connected to one another by means of detachable connecting apparatuses 30, 31, 32, 33, 34, 35, 36, 37, 38, 39 and can be replaced.

The modular configuration in particular offers the advantage of simple and cost-effective installation and maintenance by replacement of a module which may be defective by a new module.

A microprocessor or controller 22 is also integrated in the field device 10 and is connected to the current sensor 26, to the energy measurement device 28, to the hydrogen and/or oxygen pressure regulating device or devices 40, 41, and to the valve 42. The microprocessor or controller is also connected to the sensor/actuator unit 6 and thus to the wire-free communication interface 5, to the analysis module 3 and to the water pump 43. This allows information about the state of the fuel cell 14 and/or about the electrical energy that is produced to be interchanged from the microprocessor or controller via the wire-free communication interface with a central unit which is located outside the field device. In this way, the microprocessor or controller 22 can also regulate all the functional processes within the fuel cell 14.

### LIST OF REFERENCE SYMBOLS

1 Pipeline
1a Process medium
2 Sampling line
3 Measurement or control module, also referred to as an analysis module
4 Control, data acquisition and processing module
5 Wire-free communication interface
5a Direction arrow
6 Sensor/actuator unit
10 Field device
11 Housing
12 Power generation and production unit
14 Fuel cell
16 Oxygen reservoir
18 Fuel tank
20 Water reservoir unit
22 Microprocessor
24 Energy store
26 Current sensor
28 Energy measurement device
30 Connecting apparatus
31 Connecting apparatus
32 Connecting apparatus
33 Connecting apparatus
34 Connecting apparatus
35 Connecting apparatus
36 Connecting apparatus
40 Oxygen pressure regulating device
41 Fuel pressure regulating device
42 Valve
43 Water pump

1. An arrangement for supplying electrical power to a field device in a process installation which is equipped with a wire-free communication interface, without the use of wires, with at least one fuel cell having a membrane/electrode block and a fuel tank as well as an electrical energy store being integrated in a housing in the field device, comprising:
a fuel cell equipped with an oxygen reservoir which provides oxygen that is required for production of electrical energy by oxidation of the fuel in the membrane/electrode block,
a water reservoir unit which holds water which is created during the production of electrical power in the membrane/electrode block by oxidation of the fuel with the oxygen, and
wherein the fuel cell together with the membrane/electrode block, a fuel tank, the oxygen reservoir and the water reservoir unit form a closed system.

2. The arrangement as claimed in claim 1, wherein the oxygen in the oxygen reservoir is pressurized.

3. The arrangement as claimed in claim 1, wherein the pressure of the fuel at the interface between the fuel tank and the membrane/electrode block can be regulated by means of a fuel pressure regulating device and/or the pressure of oxygen at an interface between the oxygen reservoir and the membrane/electrode block can be regulated by means of an oxygen pressure regulating device.

4. The arrangement as claimed in claim 3, wherein the fuel and/or oxygen pressure regulating devices are mechanical pressure regulating valves, membrane pressure regulators or electronic pressure regulators.

5. The arrangement as claimed in claim 1, wherein the power of the fuel cell can be adjusted and/or regulated, with the fuel pressure and/or the oxygen pressure being the manipulated variables.

6. The arrangement as claimed in claim 1, wherein the water reservoir unit is a water tank which is connected to the membrane/electrode block.

7. The arrangement as claimed in claim 1, wherein the fuel cell is equipped with at least one current sensor for measurement of the electric current produced by it, or with an energy measurement device for measurement of the electrical energy produced by it.

8. The arrangement as claimed in claim 7, wherein the fuel cell together with the membrane/electrode block, the fuel tank, the oxygen reservoir, the water reservoir unit, the fuel pressure regulating device and the oxygen pressure regulating device which may be provided, the at least one current sensor or the at least one energy measurement device are formed as a modular, closed system, with the membrane/electrode block, the fuel tank, the oxygen reservoir, the water reservoir unit, the fuel and/or oxygen pressure regulating device or devices and the at least one current sensor or the at least one energy measurement device being individually replaceable modules and having the capability to be connected to one another by detachable connecting apparatuses.

9. The arrangement as claimed in claim 8, wherein the membrane/electrode block together with the fuel tank, the oxygen reservoir, the water reservoir unit, the fuel and/or oxygen pressure regulating device or devices and the current sensor or sensors or energy measurement devices are integrated in a pressure-resistant housing.

10. The arrangement as claimed in claim 9, wherein a pressure-relief valve is installed in the pressure-resistant housing and/or in the appliance housing.

11. The arrangement as claimed in claim 7, wherein the fuel cell power can be regulated by means of a microprocessor which is integrated in the field device or by means of a controller, with the microprocessor or controller being connected at least to the current sensor and/or to the energy measurement device for measurement of the electric current which is produced by the fuel cell or of the electrical energy which is produced by it, and being connected to the fuel and/or oxygen pressure regulating device or devices.

12. The arrangement as claimed in claim 11, wherein the microprocessor or controller is connected to the wire-free communication interface of the field device, and information about a state of the fuel cell and/or electrical energy produced can be interchanged by the microprocessor or controller via the wire-free communication interface with a central unit which is located outside the field device.

13. A method for supplying electrical power to a field device in a process installation which is equipped with a wire-free communication interface, without the use of wires, with at least one fuel cell having a membrane/electrode block and a fuel tank as well as an electrical energy store being integrated in the field device, comprising:
providing oxygen which is required for production of electrical power by oxidation of the fuel in the membrane/electrode block from an oxygen reservoir with which the fuel cell is equipped, and
holding in a water reservoir unit, of the fuel cell, water which is created during production of electrical power in the membrane/electrode block by oxidation of the fuel with the oxygen.

14. The method as claimed in claim 13, comprising:
regulating the pressure of the fuel at the interface between the fuel tank and the membrane/electrode block by means of a fuel pressure regulating device and/or regulating the pressure of the oxygen at the interface between the oxygen reservoir and the membrane/electrode block by means of an oxygen pressure regulating device.

15. The method as claimed in one claim 13, comprising:
measuring electric current which is produced by the fuel cell by means of a current sensor, and/or measuring the electrical energy which is produced by the fuel cell is measured by means of an energy measurement device.

16. The method as claimed in claim 15, comprising:
adjusting and/or regulating the fuel cell, with the fuel pressure and/or the oxygen pressure being the manipulated variables.

17. The method as claimed in claim 16, comprising:
regulating power of the fuel cell, with the signal from the at least one current sensor or the signal from the at least one energy measurement device being the controlled variable.

18. The method as claimed in claim 13, comprising
supplying water which is created during the production of electrical power in the membrane/electrode block on the basis of the oxidation of the fuel with the oxygen via a valve and a water pump to the water reservoir unit, and passing at least some of it back once again from there as required to the membrane/electrode block.

19. The method as claimed in claim 13 comprising:
collecting water which is created during the production of electrical power in the membrane/electrode block on the basis of the oxidation of the fuel with the oxygen within the pressure-resistant housing.

20. The method as claimed in claim 13 comprising
regulating fuel cell power by means of a microprocessor which is integrated in the field device, or by means of a controller.

21. The method as claimed in claim 20, wherein the microprocessor or controller connected to the wire-free communication interface of the field device.
